(19) United States
(12) Patent Application Publication
(10) Pub. No.: US 2026/0039120 A1
(43) Pub. Date: Feb. 5, 2026

(54) HIGH VOLTAGE PROTECTION OF ELECTROLYZER IN A WIND POWER PLANT

(71) Applicant: VESTAS WIND SYSTEMS A/S, Aarhus N (DK)

(72) Inventors: Daniel Kirkebye KAPPELGAARD, Aarhus N (DK); Søren Lund BJERREGAARD, Hvide Sande (DK); Morten Bagger SØGAARD, Thisted (DK)

(21) Appl. No.: 19/099,856

(22) PCT Filed: Aug. 8, 2023
(86) PCT No.: PCT/DK2023/050198

§ 371 Date: Jan. 30, 2025

(30) Foreign Application Priority Data
Aug. 15, 2022 (DK) PA202270406

(51) Int. Cl. H02J 3/38; H02J 3/16; H02J 3/46; H02J 13/00

(52) U.S. Cl. CPC H02J 3/388; H02J 3/16; H02J 3/46; H02J 13/00002; H02J 2203/10; H02J 2300/28

(57) ABSTRACT

The invention relates to a method for operating a renewable power plant (100) comprising at least one wind turbine (101) and an electrolyzer system (110), the renewable power plant is connectable with a grid (190) via a circuit breaker (123) located at a point of common coupling (PCC), wherein the renewable power plant comprises an internal grid (191) connecting the at least one wind turbine and the electrolyzer system with the point of common coupling, wherein the method comprises detecting a low voltage at any of the at least one wind turbine, and electrically disconnecting the electrolyzer system from the internal grid in response to detecting the low voltage.

### FIELD OF THE INVENTION

The invention relates to renewable power plants, particularly to renewable power plants comprising wind turbines and electrolyzers.

### BACKGROUND OF THE INVENTION

Renewable power plants such as wind power plants may be combined with electrolyzers for production of hydrogen. This combination may be advantageous since electrical power from the power plant may be used to produce hydrogen. Furthermore, a location of electrolyzers at the location of the renewable power plant may be an advantage compared to a remote location in view of installation costs such as installation costs for electrical grid installations to a remote location and to minimize transmission losses.

Since electrolyzers may be vulnerable to high voltages the inventors have realized that improvements of present renewable power plants are needed in order to project the electrolyzers against high voltages in the power supply and have therefore devised the present invention.

### SUMMARY

It is an object of the invention to improve renewable power plants which include electrolyzers so that the risk of damaging the electrolyzers due to high voltages in the power supply is reduced.

In a first aspect of the invention a method for operating a renewable power plant comprising at least one wind turbine and an electrolyzer system, the renewable power plant is connectable with a grid via a circuit breaker located at a point of common coupling is presented, wherein the renewable power plant comprises an internal grid connecting the at least one wind turbine and the electrolyzer system with the point of common coupling, wherein the method comprises
detecting a low voltage at any of the at least one wind turbine, and
electrically disconnecting the electrolyzer system from the internal grid in response to detecting the low voltage.

Advantageously, low voltage detectors of the wind turbines are used for determining a low voltage at a wind turbine since the low voltage could trigger the wind turbine to enter into a low voltage ride through mode where the wind turbine will start injecting reactive power into the internal grid. In an islanding mode that could have caused the low voltage measurement at the wind turbine the injection of reactive power could lead to a rapid increase of the voltage on the internal grid. Accordingly, a disconnection of the electrolyzer system could prevent high voltage damages of the electrolyzer system.

The solution according to the first aspect may be particularly advantageous when a power plant controller is not capable of communicating information of the closed-open state of the circuit breaker at the point of common coupling or voltage levels on the grid to the electrolyzer system.

The electrolyzer system is arranged to be powered via the internal grid. Therefore, the electrolyzer system may be powered via power from the wind turbines or power from the grid.

According to an embodiment, the electrolyzer system comprises a low voltage detector and a converter capable of converting DC power into AC power, wherein the method comprises,
detecting a low voltage at the electrolyzer system using the low voltage detector at the electrolyzer system, and
before electrically disconnecting the electrolyzer system from the internal grid, converting stored DC power from the electrolyzer system into AC power using the converter and injecting the AC power into the internal grid in response to detecting the low voltage at the electrolyzer system.

Detecting a low voltage at the electrolyzer system in addition to a low voltage at the one or more wind turbines indicates an actual low voltage at the grid. In this case, the injection of AC power from the electrolyzer system could support the grid during an actual low voltage ride through event (LVRT).

For example, in case a low voltage is measured at the electrolyzer system within a certain time such as before, at the same time or substantially at the same time that the electrolyzer system receives an instruction to electrically disconnect from the internal grid, the step of converting stored DC power and injecting AC power into the grid may be performed. Conversely, in case no low voltage is measured at the electrolyzer system within said certain time, this could be due to an islanding situation, in which case the step of converting stored DC power and injecting AC power into the grid is not performed.

The subsequent disconnection of the electrolyzer system would additionally help stabilize the grid voltage faster since the removal of the electrolyzer system would make it easier for the wind turbines to increase the grid voltage.

The stored DC power may be stored as a capacitance in the electrolyzer system. Thus, the DC power is stored in e.g. capacitors in the electrolyzer system. The stored DC power may be converted into active AC power, into reactive AC power or generally into an apparent power.

According to an embodiment, the wind power plant comprises a first group of one or more wind turbines and a second group of one or more other wind turbines, wherein the first group is located electrically closer to the electrolyzer system than the second group and wherein the at least one wind turbine is comprised by the first group of the one or more wind turbines.

Advantageously, the low voltage is obtained from wind turbines located electrically close to the electrolyzer system so that the deviation between the voltage at wind turbines detecting the low voltage and the electrolyzer system is minimal. Due to the complexity of an internal grid, e.g. an internal grid with parallel grid strings, there could be a risk that a low voltage measurement from a distant wind turbine is not relevant for the voltage situation near the electrolyser system, e.g. when the electrolyzer system and the distant wind turbine are located of different grid strings.

Thus, the detecting of the low voltage at any of the wind turbines may be restricted to detecting the low voltage at any wind turbine in the first group.

According to an embodiment, the power plant comprises first and second electrolyzer systems, wherein the method comprises:
electrically disconnecting the first electrolyzer system from the internal grid in response to detecting the low voltage at any wind turbine in the first group, wherein the disconnection of the first electrolyzer system is restricted to low voltages detected at any wind turbine in the first group,
electrically disconnecting the second electrolyzer system from the internal grid in response to detecting the low voltage at any wind turbine in the second group, wherein the disconnection of the second electrolyzer system is restricted to low voltages detected at any wind turbine in the second group.

Thus, the first electrolyzer system may be located electrically closer to the first group of wind turbines than the second group of wind turbines, and the second electrolyzer system may be located electrically closer to the second group of wind turbines than the first group of wind turbines.

Advantageously, the renewable power plant comprises first and second electrolyzer systems or first and second groups of electrolyzer systems each comprising one or more electrolyzer systems or electrolyzers. In this way, a plurality of electrolyzer systems can be installed in a renewable power plant while ensuring that the electrical distance between electrolyzers and low voltage measurement points at wind turbines is kept low.

According to an embodiment, the method comprises
detecting that a circuit breaker is opened to electrically disconnect the grid from the internal grid, and
in response to the detecting that the circuit breaker is opened, communicating a disconnect signal to one or more of the least one wind turbine and/or the electrolyzer system informing the recipient to electrically disconnect from the internal grid.

Advantageously, the renewable power plant may be configured with a communication means configured to inform the electrolyser system and/or one or more wind turbines that the grid circuit breaker has opened and thereby causing an islanding condition. The electrolyzer system as well as the wind turbines may be configured to disconnect from the internal grid in response to receiving the disconnect signal.

According to an embodiment, the method comprises monitoring a duration of an overvoltage at the electrolyzer system and electrically disconnecting the electrolyzer system from the internal grid dependent on the duration of the over voltage condition.

Advantageously, the timer based disconnection of the electrolyzer system provides a secondary protection of the electrolyzers, e.g. in case other actions have not been effective in preventing a voltage increase on the internal grid or at the input of the electrolyser system.

For example, the disconnection may be generated if the duration exceeds a period within a range from 10-100 ms.

According to an embodiment, the electrolyzer system comprises an auxiliary over voltage protection system arranged on a low voltage side of a transformer connected to the common connection on its high voltage side, wherein the auxiliary over voltage protection system is arranged to clamp the voltage at the low voltage side, wherein the duration of the overvoltage is monitored while clamping the voltage at the low voltage side.

Advantageously, the voltage clamping assists in bringing the voltage on the internal grid down. Accordingly, if the over voltage situation persists even with the claiming circuit activated, this indicates a severe over voltage situation requiring a disconnection of the electrolyzer system.

According to an embodiment, the overvoltage is determined based on measuring a voltage at the low voltage side of the transformer.

It may an advantage to use a voltage measured directly at the input of the electrolyzer system or near the electrolyzer system for the detection of the over voltage situation, since voltages measured at other locations in the power plant may be inaccurate in relation to the actual voltage at the input of the electrolyzer system.

A second aspect of the invention relates to a renewable wind power plant comprising at least one wind turbine and an electrolyzer system arranged connectable with a grid via a first circuit breaker located at a point of common coupling, wherein the renewable power plant comprises an internal grid connecting the at least one wind turbine and the electrolyzer system with the point of common coupling, and wherein the wind power plant comprises a second circuit breaker connecting the electrolyzer system with the internal grid, wherein the wind power plant comprises
an low voltage detector for detecting a low voltage at any of the at least one wind turbine,
at least one controller arranged to control the second circuit breaker to electrically disconnect the electrolyzer system from the internal grid in response to detecting the low voltage.

The at least one controller may comprise the power plant controller or other central relay controller arranged to receive a low voltage signal indicating the low voltage and to control or inform the second circuit breaker to open in response to the low voltage. Alternatively, the low voltage signal may be sent directly via a communication means, e.g. a communication means arranged with the voltage detector to a controller of the second circuit breaker arranged to control the circuit breaker.

A third aspect of the invention relates to computer program comprising instructions which, when the program is executed by a computer, cause the computer to carry out the method of the first aspect.

In general, the various aspects and embodiments of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows a renewable power plant including an electrolyzer system.

### DETAILED DESCRIPTION

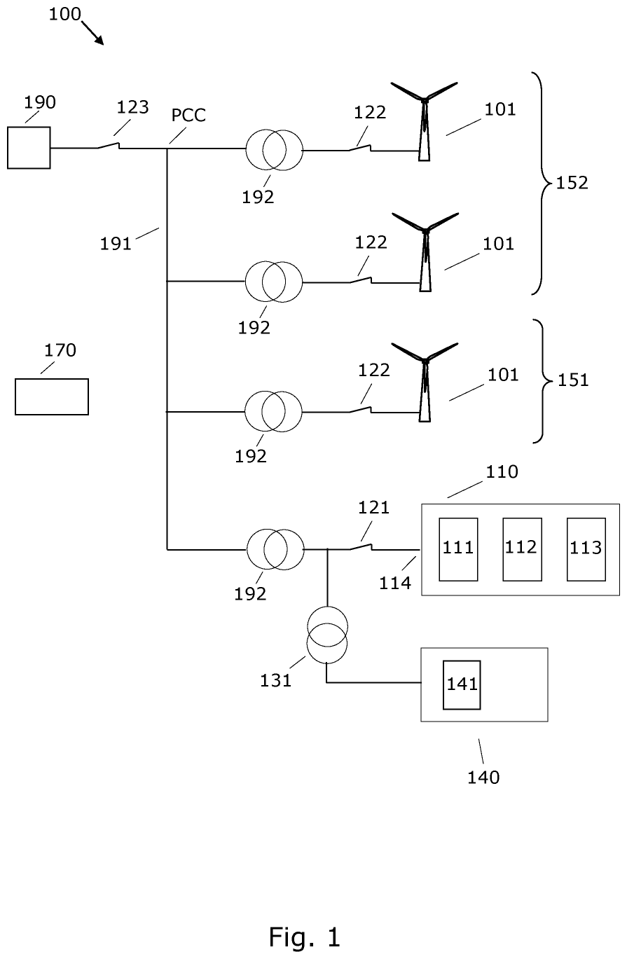

FIG. 1 shows a renewable power plant 100, such as a wind power plant which comprises one or more wind turbines 101. The power plant 100 may additionally comprise other renewable power generating units such as solar power units 103 (e.g. photovoltaic solar panels). Thus, in one example the power plant comprises only one wind turbine 101. In another example, the power plant comprises a plurality of wind turbines 101.

The power plant 100 further comprises one or more electrolyzer systems 110 arranged for production of hydrogen. For convenience FIG. 1 shows only one electrolyzer system 110.

The electrolyzer system 110 comprises an electrolyzer 113 configured to produce hydrogen through electrolysis. Each electrolyzer system 110 may comprise one or more electrolyzers.

For example, in an off shore wind power plant a single wind turbine 101 is installed on foundation comprising a platform arranged above the sea level. One or more electrolyzers 110 may be arranged on the platform. Thus, the single wind turbine 101 comprising the electrolyzer system 110 may constitute a power plant 100 or a plurality of wind turbines 101, wherein one or more wind turbines comprises an electrolyzer system 110 arranged on e.g. platforms, may be comprised by the power plant 100.

The one or more wind turbines 101 and electrolyzer systems 110 are connected to the grid 190 via an internal grid 191 providing a common electrical connection between the connected units.

Thus, the power plant 100 is connectable with the grid 190 for supplying power from the wind turbines 101 and possibly other power generating units to the grid.

Herein the grid 104 can be any of a distribution grid, a transmission grid, a medium voltage network, a high voltage grid or other electrical grid.

The internal grid 191 may be an intermediate power network comprising a power line such as a medium voltage network. The internal grid may be connected to the wind turbines 101 and electrolyzer systems 110 via transformers 192.

The electrolyzer system 110 further comprises a converter 111, e.g. a controlled converter configured with power semiconductors such as IGBTs and arranged to convert an AC voltage supplied via the internal grid 191 to a power input 114 of the electrolyzer system into a DC voltage. The electrolyzer system 110 may also comprise a DC link 112 arranged to reduce ripple voltage. The converter 111 such as a 4-quadrant converter may function as a controlled rectifier. The converter 111 may also be configured to convert DC power from stored capacitance of the electrolyzer system 110, such as from the DC link 112, into AC power for injecting the AC power into the grid 190.

Converters capable of converting AC power from the internal grid 191 into DC power as well as DC power into AC power for injection into the internal grid 191 and the external grid 190 comprise 4-quadrant converters. The electrolyzer system 110 may in alternative embodiment comprise a thyristor based rectifier 111.

Accordingly, the electrolyzer system 110 is electrically powered via power from the internal grid 191 which may originate from the grid 190, the wind turbines 101 or both.

The electrolyzer system 110 is connected to the internal grid 191 via a controllable a circuit breaker 121 arranged to electrically disconnect the converter 111 and thereby the electrolyzer 113 from the internal grid. The wind turbines 101 may be connected to the internal grid 191 via similar controllable circuit breakers 122.

FIG. 1 shows that the electrolyzer circuit breaker 121 and the wind turbine circuit breakers 122 are located on the low voltage sides of the transformers 192. Alternatively, one or more of the circuit breakers 121, 122, particularly when they are configured as switch gears, may be located on the high voltage side of the transformers 192.

The internal grid 191 and thereby the wind turbines 101 and the electrolyzer system 110 is connectable with the grid 190 via a circuit breaker 123 such as a common circuit breaker located at or in the vicinity a point of common coupling PCC. The point of common coupling PCC constitute a point within the internal grid 191 to which the circuit breaker and the wind turbines 101 and the electrolyzer system 110 are connected.

The power plant 100 may comprise a central controller 170, or the power plant controller 170 may be located externally to the power plant 100. The central controller 170 is arranged to control power generation from the wind turbines 101 according to a power plant reference which defines the desired power to be supplied to the grid.

Each wind turbine 101 may comprise a tower and a rotor with at least one rotor blade, such as three blades. The rotor is connected to a nacelle which is mounted on top of the tower and being adapted to drive a generator situated inside the nacelle. The rotor is rotatable by action of the wind. The wind induced rotational energy of the rotor blades is transferred via a shaft to the generator. Thus, the wind turbine is capable of converting kinetic energy of the wind into mechanical energy by means of the rotor blades and, subsequently, into electric power by means of the generator. The generator may include a power converter for converting the generator AC power into a DC power and a power inverter for converting the DC power into an AC power to be injected into the electrical power grid. The generator of the wind turbine 102 is controllable to produce power corresponding to power set-points provided by the central controller. For wind turbines, the output power may be adjusted according to the power set-point by adjusting the pitch of the rotor blades or by controlling the power converter to adjust the power production.

Electrolyzers 113 need to be protected against high voltages on the power supply, i.e. high voltages at the input 114. A situation may occur where the renewable power plant 100 trips at the point of common coupling PCC, i.e. where the grid circuit breaker 123 opens due to some fault like a grid fault and thereby causes an islanding condition. In this situation, the wind turbines 101 may not be able, or at least not fast enough, to detect the islanding condition, but may detect a low voltage on the internal grid 191, e.g. due to large in-plant loads such as the electrolyzer system 110, and in response to the low voltage detection enter into a low voltage ride through support mode (LVRT). Wind turbines are normally designed to shut down or to operate in a self-sustained idle mode when not connected to the grid.

During normal operation, when the renewable power plant is connected to the grid, the wind turbines inject reactive power into the internal grid 191 to increase the voltage on the grid 190 when in LVRT mode.

If the detected low voltage is made by the wind turbines in islanding condition, the injection of reactive power by the wind turbines in the subsequent LVRT mode will cause a significant increase of the voltage at the internal grid. This increase will be substantially faster than when operating in a grid connected mode—due to a higher impedance in the renewable power plant when in islanding mode compared to grid connected mode. The high voltage could damage the electrolyzer stacks of the electrolyzers 113 as well as other components in the renewable power plant.

If the detected low voltage is not due to the islanding condition, but is in fact due to a low grid voltage on the grid 190, the injection of reactive power in the subsequent LVRT mode will not cause a significant increase of the voltage at the internal grid since the grid circuit breaker 123 is closed.

The LVRT mode of the wind turbines may be triggered by various conditions. Examples of LVRT conditions comprise:
the voltage at the wind turbine 101 is less than a lower threshold, and/or
the occurrence of an abrupt voltage change (ΔV=V−Vprefault) at the wind turbine 101 which exceeds a tolerance voltage band, wherein V is an rms voltage in a moving window at the wind turbine 101 and Vprefault is an average value.

For the purpose of detecting the LVRT mode, the wind turbines 101 comprise voltage detectors such as low voltage detectors arranged to detect the voltage.

Additionally, the electrolyzer system 110 may be configured with a voltage detector such as a low voltage detector arranged to measure the voltage level at the power input 114. Alternatively, an auxiliary over voltage protection system 140 comprised by the power plant 100 or the electrolyzer system 110 may be configured with a voltage detector arranged to measure a voltage level corresponding to the voltage level at the input 114 of the electrolyzer system 110. The over voltage protection system 140 is connected to the internal grid 191 via a transformer 131 with the low voltage side of the transformer 131 being connected to the over voltage projection system 140 and the high voltage side being connected to the internal grid 191. The voltage detector of the over voltage protection system 140 is arranged on the low voltage side of the transformer.

Thus, the voltage detector such as the low voltage detector of the of electrolyzer system 110 is configured to determine a voltage relating to the voltage at the input 114 of the electrolyzer system 110 such as the voltage at the low voltage side of the transformer 131.

It could be straightforward to use the voltage measurement from the voltage detector of the electrolyzer system 110 to check for a possible low voltage condition. However, due to different grid properties seen from the wind turbines 101 and the electrolyzer system 110 it may not be possible to implement a suitable LVRT algorithm in the electrolyzer, or at least it may not be possible to use the same LVRT algorithm in the electrolyzer as used in the wind turbines.

Therefore, in an embodiment, a method for operating a renewable power plant 100 and protecting the electrolyzer system 110 against high voltages is based on using the wind turbine's 101 voltage detectors which are configured for determining the occurrence of a low voltage event. The voltage detector of a given wind turbine 101 may be arranged to measure the voltage on the connection between the circuit breaker 122 or the transformer 192 and the power converter of the wind turbine 101. According to this method, if a low voltage is detected at any of the of the one or more wind turbines 101, the electrolyzer system 110 will be disconnected from the internal grid 191 by opening the electrolyzer system's circuit breaker 121, also referred to the as the second circuit breaker 121.

However, in case the low voltage measured at the wind turbines 101 is not due to tripping of the grid circuit breaker 123, also referred to as the first circuit breaker 123, a low voltage at the grid 190 may be present.

Therefore, in order to better account for this situation with an actual low voltage event, the electrolyzer system 110 is configured with a voltage detector such as a low voltage detector and the converter 111 is configured to convert DC power into AC power for injecting the AC power into the internal grid 191 and the external grid 190. According to this embodiment, if a low voltage is detected at the electrolyzer system 110 using the electrolyzer system's 110 voltage detector in addition to the low voltage detection at any of the of the one or more wind turbines 101, the electrolyzer system 110 is initially controlled to convert stored DC power from the electrolyzer system into AC power and to inject the AC power into the internal grid 191 before disconnecting the electrolyzer system 110 from the internal grid 110. The subsequent disconnection of the electrolyzer system 110 makes it easier for the wind turbines 101 to increase the voltage on the internal grid 191 and the external grid 190 since the disconnection of the electrolyzer system increases the impedance that the wind turbines sees into.

The DC power is stored as a capacitance, i.e. a charge, in the electrolyzer system such as in the DC-link 112 and/or other capacitors comprised by the electrolyzer system. The converter 111 may be controlled to convert the stored DC power into reactive AC power for assisting in increasing the grid voltage and/or into active AC power. The injection of reactive and active power generally helps stabilizing the grid voltage.

Due the impedance of the internal grid 191 between the electrolyzer system 110 and any of the wind turbines 101, the voltage measured at a wind turbine 101 may deviate from the voltage at the electrolyzer system 110. Therefore, it may be advantageous to decide if the electrolyzer system 110 should be disconnected based on detecting a low voltage at one or more wind turbines that are located electrically close to the electrolyzer system 110 compared to other wind turbines, i.e. electrically close meaning that the impedance or length of the interconnection on the internal grid 191 between the one or more wind turbines 101 where the voltage is detected for determination of an electrolyzer disconnection is lower than the impedance or length of the interconnection between the electrolyzer system 110 and other wind turbines 101 that are not used as a basis for deciding to disconnect the electrolyzer system 110.

Accordingly, the wind power plant 100 may comprise a first group 151 of one or more wind turbines and a second group 152 of one or more other wind turbines, wherein the first group 151 is located electrically closer to the electrolyzer system 110 than the second group and wherein the at least one wind turbine which is used as a basis for detecting the occurrence of a low voltage for deciding a disconnection of the electrolyzer system 110 is comprised by the first group 151 of one or more wind turbines 101. In this context, electrically close means that a length or impedance of an interconnection on the internal grid 191 between the first group 151 and the electrolyzer system 110 is lower than a length or impedance of an interconnection on the internal grid 191 between the second group 152 and the electrolyzer system 110.

Thus, while any of the wind turbines 101 may be provided with voltage detectors, the detection of a low voltage for the purpose of determining a possible disconnection of the electrolyzer system 110 may be restricted to low voltages detected at wind turbines located electrically closest to the electrolyzer system 110 or to wind turbines in the first group 151. Similarly, the electrolyzer system 110 such as a controller thereof may be configured to determine a disconnection from the internal grid 191 based only from one or more wind turbines 101 in the first group 151.

The power plant 100 may comprises a plurality of electrolyzer systems 110 or a plurality of groups of electrolyzer systems 110 such as first and second groups of electrolyzer systems. Each of the individual electrolyzer systems 110 or each of the groups thereof may be associated with different wind turbines 101 or different groups of wind turbines located electrically closest to the associated electrolyzer system or group of electrolyzer, wherein closest refers to comparison with other wind turbines or groups thereof. Thus, the low voltage detection of a wind turbine or a group thereof associated with an electrolyzer system 110 or a group thereof is used as a basis for determining a possible disconnection of the associated electrolyzer system 110 or the group thereof.

Thus, in general the power plant 100 may comprise first and second electrolyzer systems or first and second groups of electrolyzer systems, wherein the determination of electrically disconnecting the first electrolyzer system or first group thereof from the internal grid 191 in response to detecting the low voltage is restricted to low voltages detected at any wind turbine in the first group 151 of one or more wind turbines 101 associated with the first electrolyzer system or the first group of electrolyzers, and wherein the determination of electrically disconnecting the second electrolyzer system or second group thereof from the internal grid 191 in response to detecting the low voltage is restricted to low voltages detected at any wind turbine in the second group 152 of one or more wind turbines associated with the second electrolyzer system or the second group of electrolyzers, wherein the at least some of the one or more wind turbines of the first and second groups of wind turbines are different, or wherein any of the one or more wind turbines of the first group of wind turbines are different from any of the one or more wind turbines of the second group of wind turbines.

In an example, each of the first and second groups 151, 152 of one or more wind turbines has one or more electrolyzer systems which are paired specifically with one of the first and second groups 151, 152, wherein the paring implies that the detecting of a low voltage for the purpose of determining a possible electrical disconnection of that one or more electrolyzer systems from the paired one or more wind turbines is made at that one or more wind turbines.

In an example, each single wind turbine is paired with one or more electrolyzer systems and the low voltage is detected at that single wind turbine.

According to another embodiment the renewable power plant 100 is configured to detect if the grid circuit breaker 123 is opened to electrically disconnect the grid 190 from the internal grid 191 and to communicate a disconnect signal to the electrolyzer system 110 and/or to one or more of the wind turbines 101 in response to a detection of an open state of the grid circuit breaker 123. For example, the power plant controller 170 may be configured to send the disconnect signal in response to an instruction sent to the grid circuit breaker to open or in response to a signal from the grid circuit breaker 123 or a controller thereof. In response to receiving the disconnect signal, the receiving wind turbine 101 or electrolyzer system 110 performs the disconnection from the internal grid 191 by instructing the internal grid circuit breaker 121, 122 to open, such as the electrolyzer system's circuit breaker 121 and/or any of the wind turbine's 101 circuit breaker 122 to open.

The electrolyzer system 110 or the over voltage protection system 140 may comprise a means such as a timer or counter for determining a duration of an over voltage relating to an over voltage at the input 114 of the electrolyzer system 110. An over voltage may be a voltage which exceeds a voltage threshold defined by the nominal voltage on the internal grid 191 or a maximum operational voltage of the electrolyzer system 110 such as voltage defined by a voltage margin of a critical destruction voltage level of the electrolyzer 113.

The over voltage may be measured by a voltage detector comprised by the over voltage protection system 140 arranged on the low voltage side of the transformer 131 connecting the voltage protection system 140 to the internal grid 191.

A fault situation may occur where the electrolyzer system 110 has not been disconnected from the internal grid 191 in response to detecting a low voltage at any of the at least one wind turbine 101, or in response to detecting that the grid circuit breaker 123 is opened to electrically disconnect the grid 190 from the internal grid 191. In this faulty situation, the duration of an over voltage, e.g. caused by an LVRT mode, may be used to trigger a disconnection of the electrolyzer system 110 from the internal grid 191. E.g. if the duration exceeds a predetermined time limit, the disconnection be invoked.

The auxiliary over voltage protection system 140 may comprise a clamping circuit 141 arranged to clamp the voltage at the low voltage side of the transformer 131, e.g. dependent on a request. The clamping circuit may be arranged to clamp the voltage to a predetermined voltage. The purpose of the clamping circuit 141 is to protect auxiliary loads against over voltages. The clamping circuit may be activated dependent on a request, such as a determined electrical characteristic of the over voltage protection system 140 so that the circuit will clamp the input voltage of the over voltage protection system 140 if the electrical characteristic becomes too high.

The clamping circuit may comprise a metal-oxide-varistor arranged to clamp the voltage which will cause a reduction of the voltage on the low voltage side of the transformer 131 and therefore also on the high voltage side. Accordingly, activating the clamping circuit also brings down the voltage of the high voltage side of the transformer 131.

The overvoltage voltage projection system 140, such as the timer thereof, may be configured to determine the duration of the over voltage while the voltage is clamped. In this way, if the determined duration exceeds a maximum duration this would indicate a more severe over voltage situation and therefore a need for disconnecting the electrolyzer system 110.

1. A method for operating a renewable power plant comprising at least one wind turbine and an electrolyzer system, the renewable power plant is connectable with a grid via a circuit breaker located at a point of common coupling, wherein the renewable power plant comprises an internal grid connecting the at least one wind turbine and the electrolyzer system with the point of common coupling, wherein the method comprises
detecting a low voltage at any of the at least one wind turbine,
electrically disconnecting the electrolyzer system from the internal grid in response to detecting the low voltage.

2. A method according to claim 1, wherein the electrolyzer system comprises a low voltage detector and a converter capable of converting DC power into AC power, wherein the method comprises,
detecting a low voltage at the electrolyzer system using the low voltage detector at the electrolyzer system, and
before electrically disconnecting the electrolyzer system from the internal grid, converting stored DC power from the electrolyzer system into AC power using the converter and injecting the AC power into the internal grid in response to detecting the low voltage at the electrolyzer system.

3. A method according to claim 2, wherein the stored DC power is stored as a capacitance in the electrolyzer system.

4. A method according to claim 2, wherein the stored DC power is converted into active AC power.

5. A method according to claim 2, wherein the stored DC power is converted into reactive AC power.

6. A method according to claim 1, wherein the wind power plant comprises a first group of one or more wind turbines and a second group of one or more other wind turbines, wherein the first group is located electrically closer to the electrolyzer system than the second group and wherein the at least one wind turbine is comprised by the first group of the one or more wind turbines.

7. A method according to claim 6, wherein the detecting of the low voltage at any of the wind turbines is restricted to detecting the low voltage at any wind turbine in the first group.

8. A method according to any of the claims claim 7, wherein the power plant comprises first and second electrolyzer systems, wherein the method comprises:
electrically disconnecting the first electrolyzer system from the internal grid in response to detecting the low voltage at any wind turbine in the first group, wherein the disconnection of the first electrolyzer system is restricted to low voltages detected at any wind turbine in the first group,
electrically disconnecting the second electrolyzer system from the internal grid in response to detecting the low voltage at any wind turbine in the second group, wherein the disconnection of the second electrolyzer system is restricted to low voltages detected at any wind turbine in the second group.

9. A method according to claim 8, comprising
detecting that a circuit breaker is opened to electrically disconnect the grid from the internal grid
in response to the detecting that the circuit breaker is opened, communicating a disconnect signal to one or more of the least one wind turbine and/or the electrolyzer system informing the recipient to electrically disconnect from the internal grid.

10. A method according to claim 9, wherein the method comprises monitoring a duration of an overvoltage at the electrolyzer system and electrically disconnecting the electrolyzer system from the internal grid dependent on the duration of the over voltage condition.

11. A method according to claim 10, wherein the electrolyzer system comprises an auxiliary over voltage protection system arranged on a low voltage side of a transformer connected to the common connection on its high voltage side, wherein the auxiliary over voltage protection system is arranged to clamp the voltage at the low voltage side, wherein the duration of the overvoltage is monitored while clamping the voltage at the low voltage side.

12. A method according to claim 11, wherein the overvoltage is determined based on measuring a voltage at the low voltage side of the transformer.

13. A method according to claim 12, wherein the electrolyzer system is arranged to be powered via the internal grid.

14. A renewable wind power plant comprising at least one wind turbine and an electrolyzer system arranged connectable with a grid via a first circuit breaker located at a point of common coupling (PCC), wherein the renewable power plant comprises an internal grid connecting the at least one wind turbine and the electrolyzer system with the point of common coupling, and wherein the wind power plant comprises a second circuit breaker connecting the electrolyzer system with the internal grid, wherein the wind power plant comprises
an low voltage detector for detecting a low voltage at any of the at least one wind turbine,
a control system for controlling the second circuit breaker to electrically disconnect the electrolyzer system from the internal grid in response to detecting the low voltage.

15. A computer program comprising instructions which, when the program is executed by a computer, cause the computer to carry out an operation of a renewable power plant comprising at least one wind turbine and an electrolyzer system, the renewable power plant being connectable with a grid via a circuit breaker located at a point of common coupling (PCC), wherein the renewable power plant comprises an internal grid connecting the at least one wind turbine and the electrolyzer system with the point of common coupling, wherein the operation comprises:
detecting a low voltage at any of the at least one wind turbine; and
electrically disconnecting the electrolyzer system from the internal grid in response to detecting the low voltage.
